(19) United States
(12) Patent Application Publication
(10) Pub. No.: US 2007/0199241 A1
(43) Pub. Date: Aug. 30, 2007

(54) Structure For Planted Wall

(75) Inventor: Pascal Peleszezak, Feyzin (FR)

Correspondence Address: OLIFF & BERRIDGE, PLC, P.O. BOX 19928, ALEXANDRIA, VA, 22320, US

(73) Assignee: Canevaflor, Lyon (FR)

(21) Appl. No.: 11/630,210

(22) PCT Filed: Jun. 28, 2005
(86) PCT No.: PCT/FR05/01629

§ 371 Date: Feb. 13, 2007

(30) Foreign Application Priority Data
Jun. 30, 2004 (FR) 0407244

(51) Int. Cl. A01G 9/02

(52) U.S. Cl. 47/65.9

(57) ABSTRACT

A light self-supporting vegetated wall includes globally prismatic boxes, designed to be juxtaposed and/or stacked, the adjacent boxes being assembled together. Each box includes latticed or meshed surfaces, lined internally with a web, and filled with a cultivating substrate, such as humus. A network of water pipes and a network of air vents may be incorporated in the thickness of the structure, these networks passing through the parting lines between the boxes. The structure is designed for urban enhancement, as well as for producing noise screens, partition walls, hoardings and the like.

The present invention relates to an improved structure for a planted wall that can have a variety of functions and uses such as: urban landscaping, noise screens, antidazzle screens, walls for separating carriageways or bicycle tracks, fencing around building sites, safety barriers for swimming pools, and so forth.

In general terms it is already prior art to make planted walls, for example alongside carriageways, or on the aides of buildings or other unsightly walls that want concealing.

One planted-wall system consisting of stackable blocks of concrete forming hollow columns filled with topsoil is known. As will readily be understood, this is a heavy structure and is difficult to transport and install, and its range of possible uses is very limited; furthermore, this structure can only be planted up on one face. The prior art also includes a system that uses superposed panels of rockwool, but in order to plant this up it requires the addition of “mats” pregrown in a greenhouse and stabilized with wire netting.

Another known system for making planted walls consists of metal wire-netting “boxes” filled with a planting substrate such as compost, these boxes being prism-shaped and therefore being able to be juxtaposed and superposed and joined together to form a wall structure of the desired length and height. Examples of this may be found in U.S. Pat. No. 4,961,284, U.S. Pat. No. 5,373,662, French patent application FR 2 731 874, and German patent application DE 2 636 917.

Generally speaking, the boxes disclosed in those documents possess a wire-netting front face and/or rear face, but the other four faces, namely the bottom, top and side faces, are solid faces. As a result of this, filling an assembly of such boxes with compost is difficult, and the same may be said of the periodic replacement of the compost, which must be renewed every two to three years. Moreover, the presence of the solid bottom, top and side faces makes it problematic to install an irrigation network in such a planted-wall structure. Thus, the aforementioned U.S. Pat. No. 4,961,284 provides only a few perforated irrigation tubes embedded in the compost, these tubes not being connected to any supply network, the water being conveyed purely by gravity, without the possibility of horizontal distribution. In the case of the aforementioned U.S. Pat. No. 5,373,662, the irrigation tubes incorporated in the various superposed boxes have to be connected together by means of external connectors and sleeves, which project from the front or rear face of the structure to get around the obstacles formed by the solid bottom and top faces.

Again, most current planted-wall structures of this kind are not self-supporting, and their boxes have to be mounted on a supporting framework, as shown in the aforementioned documents FR 2 731 876 and DE 2 636 917. Where this is done, the structure can only be planted up on its front face because its rear face is held against the supporting structure.

The present invention seeks to eliminate these drawbacks by providing a structure for a planted wall that is lightweight and therefore easy to transport and install, and that is self-supporting so that it requires no supporting wall or supporting framework and can thus be used in a greater variety of applications, the structure also being easy to equip with a complete irrigation network, and being capable of being planted up on both faces.

To this end, the subject of the invention is a structure for a planted wall, of the kind made up of boxes of prismatic general shape designed to be juxtaposed and/or superposed, adjacent boxes being joined together, each box possessing wire-netting or chain-link faces, and the boxes being designed to be filled with a planting substrate such as compost, this planted-wall structure being characterized in that the bottom, top and side faces of its boxes are perforated, and in that the structure accommodates a network of water pipes, and optionally also a network of air drains, which networks run within the thickness of the various juxtaposed and/or superposed boxes, and thus within the planting substrate and across the horizontal and/or vertical joins between adjacent boxes.

In a preferred embodiment of this structure for a planted wall, each box has a structural frame supporting fixed wire-netting or chain-link faces, variously at the bottom, at the top, at the sides and at the rear, while the front face of the box is a removable subframe of wire netting or chain link.

The invention thus provides a structure made up of “blocks” or “bricks” that can be juxtaposed and superposed, each “block” or “brick” being however highly perforated, and filled with for example compost in which the roots of the plants can develop. The resulting boxes placed side by side and on top of each other, are joined together by means of screws which detachably connect their respective structural frames. The removability of the front faces of the boxes makes it easy to place internal components inside them, such as the water and air networks and their brackets, as detailed below.

In a preferred arrangement, the front face and the rear face of each box are lined internally with a mat or fabric, optionally with perforations or slits, through which the plants can be planted and can develop. This mat or fabric, forming a sort of “mulch”, can fulfill various functions such as compost retention, water or moisture retention, protection, a visual guide when planting up in a predetermined pattern, decoration, a support for lighting e.g. by means of optical fibers, and so forth.

The structure for a planted wall to which the present invention relates has as an essential feature the incorporation of a network of water pipes, and optionally also a network of air drains, which run within the thickness of the various boxes and across the horizontal and/or vertical joins between adjacent boxes, this being made possible by the fact that the bottom, top and side faces of all the boxes are perforated. The installation of these networks is thus made simpler, as are the initial introduction and subsequent replacement of the compost, since all the internal volumes of the boxes together form as it were a single uncompartmentalized volume. The water and air networks may be branched, or looped to prevent losses of head and to improve flow rates, with suitable pumps to pump the water or move the air. Insofar as the water and air networks possess horizontal pipes, which distribute the water and air to juxtaposed boxes, the structure also advantageously comprises cradles hooked to one face of the boxes, such as the rear wire-netting or chain-link face, which each support a corresponding horizontal length of water pipe or air pipe, in such a way as to position this pipe in the thickness of a box. In particular, the water and air networks may posses parallel superposed horizontal pipes running through the same boxes, in which case the cradles supporting the superposed lengths of these pipes can be connected to form a single rigid U-shaped part.

All in all, the structure for a planted wall to which the present invention relates has the following advantages:

The boxes, having this highly perforated structure due to the fact that all of their faces are made of wire netting or chain link or are perforated, are lightweight parts that are easy to transport and handle and are easily installed.

However, being made rigid by their structural frames and by their joining together, the boxes make it possible to create a rigid self-supporting structure, even to a great height. In particular, the structure does not need to be supported by a masonry wall.

As a consequence of the above, the structure for a planted wall to which the invention relates is independent and can be installed anywhere. This greatly increases the number of ways in which it can be used. If it is installed at a distance from any masonry wall, or other obstacle, the structure for a planted wall to which the invention relates can be planted up on both its main faces, front and rear, to make a kind of hedge.

The boxes form a modular planted-wall system that can be adapted to any desired shape or size. Because of this detachable modular structure, damaged parts can if desired be replaced quickly and easily by replacing boxes.

Owing to its modular character, and to the low weight of its components, this structure for a planted wall can if desired easily be dismantled and moved from one place of installation to another. This opens the way to interesting uses, particularly as temporary fencing for building sites.

The wire-netting or chain-link or perforated structure allows the water and air networks to pass freely from one box to the next, without the need for pipe connectors between adjacent boxes. This simplifies the manufacture and installation of the whole. The cradles ensure precise positioning of the pipes of these networks.

Because of their wire-netting or chain-link form, the boxes can if desired be arched to create planted walls of curved shapes, either in order to follow a particular outline or to create effects of relief or variable thickness, as for example by forming rounded areas on the front faces of the boxes.

The front faces of the boxes, being removable, allow easy access (after partly removing the compost, if desired) to the water and air networks in order to carry out work on these networks without disassembling the structure.

This reduces the cost of maintaining this structure for a planted wall.

Because of the presence of the water and air networks, the planted wall is irrigated and aerated in an evenly distributed manner, and it itself removes contaminants from the air, notably when using a filtering substrate with bacterial additive. The irrigation can be made automatic, and can be an entirely autonomous function if a solar-powered pump is provided and rainwater collected for example in a tank is used.

Lastly, the structure to which the invention relates can be used to create continuous and complete coverage of vegetation without interruptions at the joins between juxtaposed or superposed boxes. The plants can be planted directly on the components or the wall, with no particular planting restrictions concerning in particular the density of the plants, and the plants can be either climbing or trailing. The plants can easily be changed, on the structure itself.

A clearer understanding of the invention will be gained from the following description, which refers to the attached diagrammatic drawing showing, by way of examples, various embodiments of this structure for a planted wall.

FIG. 1 is a partly exploded perspective view of a structure for a planted wall according to the present invention;

FIG. 2 is a vertical section showing a detail of two superposed boxes of this structure for a planted wall;

FIG. 3 is a front view with partial section showing a variant of the planted-wall structure to which the invention relates;

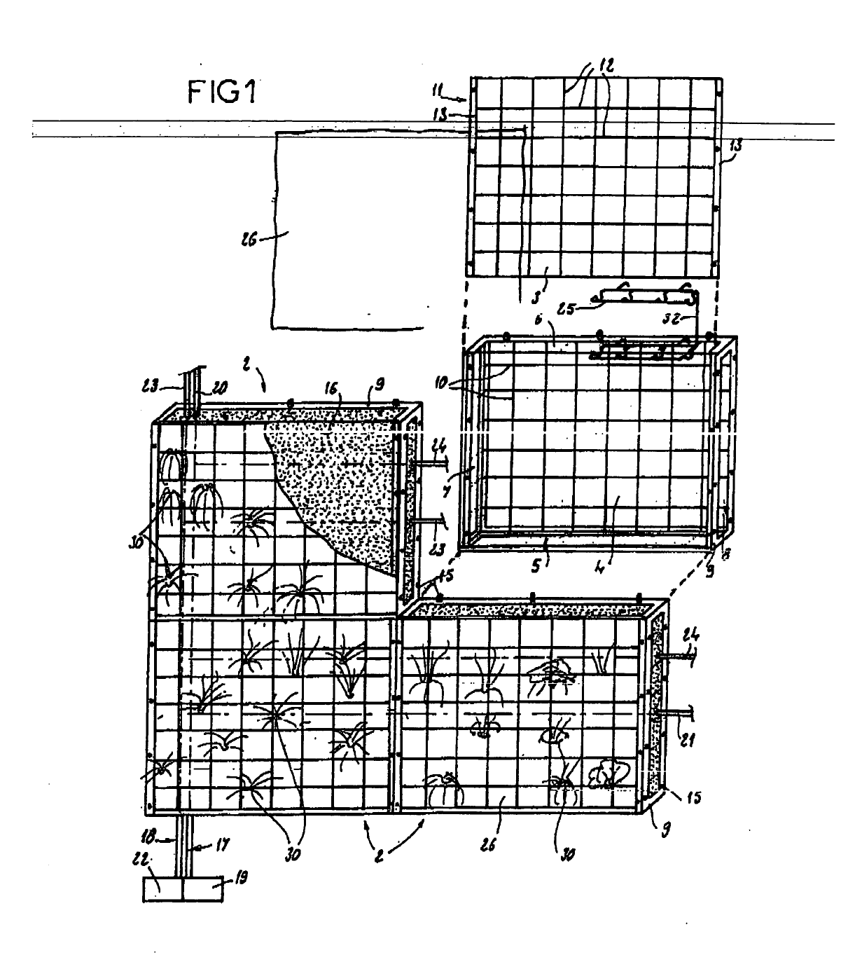

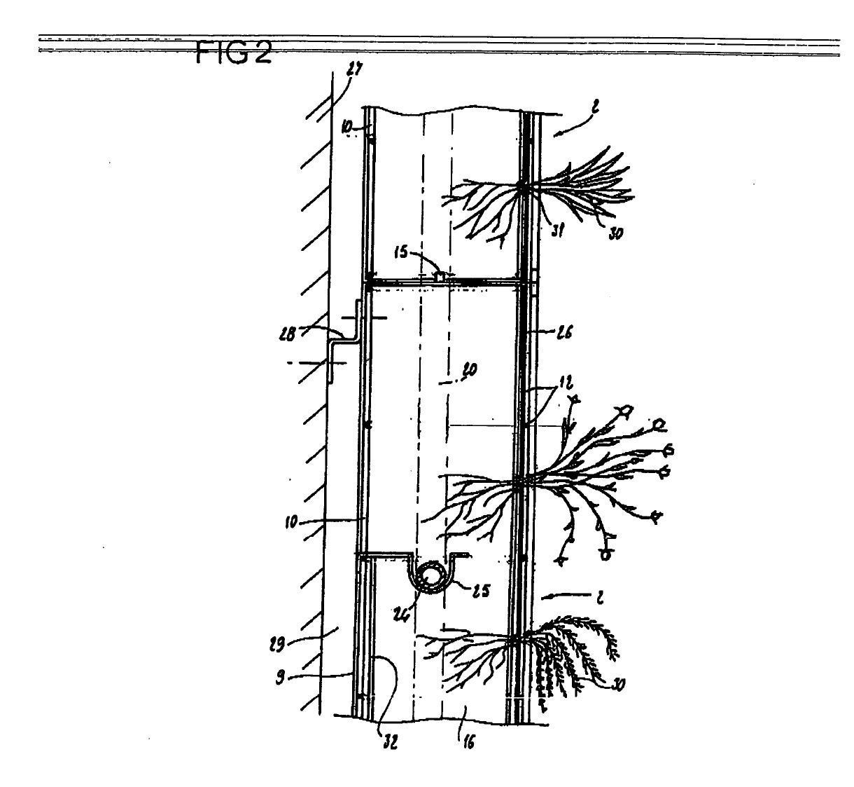

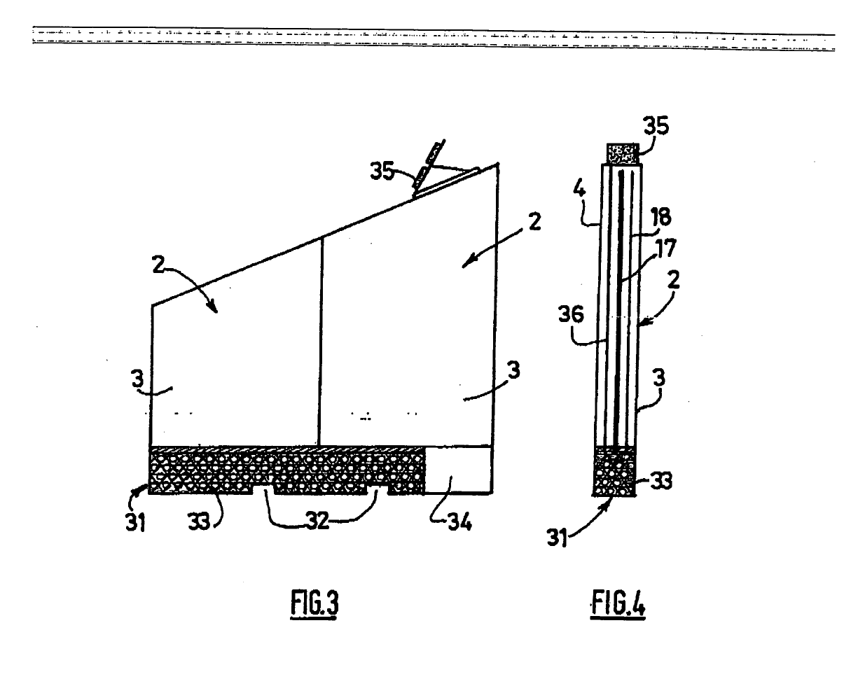

FIG. 4 is a vertical section corresponding to FIG. 3.

As FIG. 1 shows, the structure for a planted wall is made up of identical boxes 2 which are juxtaposed and superposed to form an assembly of the desired length and height.

Each box 2 possesses a parallelepiped general shape, of relatively shallow thickness, in which may be distinguished a front face 3, a rear face 4, a bottom face 5, a top face 6, and two side faces 7 and 8, left-hand and right-hand, respectively, all these faces being rectangular.

The box 2 possesses a structural frame 9, of which the component parts, which are such things as bars or angle brackets, extend along the edges of the parallelepiped. Stretched between the component parts of the structural frame 9 are metal wires 10 forming wire netting or chain link: this is present on the rear face 4, the bottom face 5, the top face 6, and optionally on the two side faces 7 and 8. However, given that the bottom 5, top 6 and aide 7 and 8 faces are not very wide, they may also simply be perforated, and need not have any wire netting.

The front face 3 of the box 2 is formed by a removable subframe 11 on which is stretched metal wire netting or chain link 12. In particular, the subframe 11 possesses lateral uprights 13 designed to be fixed removably to the sides of the structural frame 9 of the box 2 by means of screws 14.

Other screws 15 are provided in order to detachably connect the respective structural frames 9 of the boxes 2 placed side by side and on top of each other. This gives a self-supporting vertical structure.

Both the structural frames 9 and the wires 10 and 12 of the wire netting or chain link of the resulting boxes 2 may be made in particular from galvanized steel.

These boxes 2 are designed to be filled with a planting substrate 16 such as compost, turf, gravel, rocks and so forth. The removability of the front face 3 of the boxes 2 makes it easier to install the planting substrate 16.

Buried within the thickness of the boxes 2, and therefore in the planting substrate 16, are a network 17 of water pipes, and a network 18 of air drains.

The water network 17 for irrigating the planted wall comprises a pump 19 at the base of the wall, supplying a vertical water pipe 20 to which are connected horizontal water pipes 21 situated at a number of levels to irrigate the various boxes 2.

In a similar way the air network 18 comprises a pump 22 at the base of the wall, supplying a vertical air pipe 23 to which are connected horizontal air drains 24 situated at a number of levels to aerate the various boxes 2.

In particular, each horizontal row of boxes 2 may contain a horizontal water pipe 21 and a horizontal air drain 24, one above the ocher, which run through the vertical joins between adjacent boxes 2, this being permitted by the perforated side faces 7 and 8 of these boxes 2. In each box 2, suitably shaped cradles 25 are hooked to the rear face 4 and each support a corresponding length of the horizontal water pipe 21 or of the horizontal air drain 24. Two superposed cradles 25 are advantageously connected by a vertical linking bar 32 to make a single rigid U-shaped part.

The front face 3 and the rear face 4 of each box 2 are covered internally with a mat or fabric 26, which may for example be stapled or glued in place, to hold the planting substrate 16 in position.

In one possible use, illustrated in FIG. 2, the planted-wall structure is erected in front of a masonry wall 27 belonging for example to a building, and spacers 28 hold said structure at a distance from the masonry wall 27, creating an intermediate air gap 29 that isolates the wall 27 acoustically and thermally and prevents the infiltration of water and moisture, especially as the spacers 28 do not have to be anchored deeply in the wall 27.

Staying with the example of use shown in FIG. 2, plants 30 are put in position through perforations or slits 31 in the mat or fabric 26, in such a way that their roots develop in the planting substrate 16 irrigated by the water pipes 21 and aerated by the air drains 24. Pockets can be formed in the mat or fabric 26 to direct the growth of the plants 30, for example upward.

As will readily be appreciated, on the assumption that the structure for a planted wall is not placed in front of a wall, it becomes possible to use this structure with plants planted on the front faces 3 and also on the rear faces 4 of the boxes 2, in which case the rear faces 4 will also be covered with a fabric.

Whereas FIGS. 1 and 2 show an essentially fixed planted-wall structure, FIGS. 3 and 4 illustrate a variant consisting of a structure that is similar but mobile, in other words transportable from one place of use to another, or to a place of intermediate storage between two successive uses. The structure here is made up of two juxtaposed boxes 2 supported on a base 31 which may be mounted on wheels (not shown), and which advantageously comprises slots 32 for handling with a forklift truck. To make such a structure transportable and independent, the base 31 may incorporate a water tank 33, with a submerged pump 34, supplying the water network of the boxes 2. A photovoltaic panel 35 connected to a battery, by way of a source and store of autonomous electrical energy, supplies on an electrical line 36 the energy necessary to run the irrigation pump 34, and where relevant to power other auxiliary electrical functions, in particular lighting. An installation such as this is particularly suitable for décor at events, hence temporary.

Although the bottom 5, top 6 and side 7, 8 faces of the boxes 2 are perforated, by the very principle of the invention, it is still possible to create within the volume of the planted-wall structure partial separations at intermediate levels to keep the planting substrate 16 in place. This will ensure that the planting substrate does not become packed down, particularly in the case of a very tall structure, and the density of the substrate will remain substantially equal throughout the height of the structure.

In the light of the possible ways in which it can be used, the structure for a planted wall to which the invention relates can be applied in many different ways:
urban landscaping, particularly for concealing or covering side walls and other walls of buildings;
noise screens;
protection from the wind, weather and sun;
protection against vandalism;
dividing walls, for carriageways or bicycle tracks;
fencing for building sites, taking advantage of the fact that this planted-wall structure can be dismantled and transported about;
décor for temporary installations, such as exhibition stands or the like;
hedges and fences, e.g. for gardens, or more specifically for making safety barriers around a swimming pool;
making garden mazes.

Clearly, as will have been apparent from the foregoing, the invention is not limited to only those embodiments of this planted-wall structure which have been described above by way of example. On the contrary, it encompasses all variant embodiments and applications that follow the same principle, within the scope of the appended claims. Thus, for example, it would not be a departure from the scope of the invention to:
modify the shapes, dimensions and materials of the boxes, particularly by forming non-parallelepiped boxes but boxes with inclined faces, to adapt them to certain uses;
create windows or openings in or between the boxes;
use any means of joining these boxes together;
give some other configuration, for example looped, to the water and air networks;
design the air network not as a network for aerating the substrate and the roots, with perforated pipes, but as a simple heat exchanger with non-perforated air tubes, for cooling the air in rooms, both possibilities indicated here being combinable if desired in a single planted wall;
dress the visible face or faces of the structure with external fabrics for embellishment;
add any additional features, for example sprinklers, or misting or lighting systems, or air purifying systems using active carbon or other appropriate products, to this planted-wall structure;
employ the same structure for any use, indoors or outdoors.

1. A structure for a planted wall, made up of boxes of prismatic general shape designed to be juxtaposed and/or superposed, adjacent boxes being joined together, each box possessing wire-netting or chain-link faces, and the boxes being designed to be filled with a planting substrate such as compost, wherein the bottom, top and side faces of the boxes are perforated, and the structure accommodates a network of water pipes, and optionally also a network of air drains, which networks run within the thickness of the various juxtaposed and/or superposed boxes, and thus within the planting substrate and across the horizontal and/or vertical joins between adjacent boxes.

2. The structure for a planted wall as claimed in claim 1, wherein each boxy has a structural frame supporting fixed wire-netting or chain-link faces, variously at the bottom, at the top, at the sides and at the rear, while the front face of the box is a removable subframe of wire netting or chain link.

3. The structure for a planted wall as claimed in claim 2, wherein the boxes, placed side by side and on top of each other, are joined together by means of screws which detachably connect their respective structural frames.

4. The structure for a planted wall as claimed in claim 3, wherein the wire-netting or chain-link subframe of the front face of each box is fixed removably to the structural frame of this box by means of other screws.

5. The structure for a planted wall as claimed in claim 1, wherein the front face and the rear face of each box are lined internally with a mat or fabric, optionally with perforations or slits, through which the plants can be planted and can develop.

6. The structure for a planted wall as claimed in claim 1, wherein, insofar as the water and air networks possess horizontal pipes, this structure comprises cradles hooked to one face of the boxes, such as the rear wire-netting or chain-link face, which each support a corresponding horizontal length of water pipe or air pipe, in such a way as to position this pipe in the thickness of a box.

7. The structure for a planted wall as claimed in claim 6, wherein the water and air networks possess parallel superposed horizontal pipes running through the same boxes, and the cradles supporting the superposed lengths of these pipes are connected to form a single rigid U-shaped part.

8. The structure for a planted wall as claimed in claim 1, wherein it is designed as a mobile or transportable structure.

9. The structure for a planted wall as claimed in claim 1, wherein within its volume it comprises partial separations situated at intermediate levels to retain the planting substrate.
